(19) United States
(12) Patent Application Publication
(10) Pub. No.: US 2016/0180095 A1
(43) Pub. Date: Jun. 23, 2016

(54) MEASURED BOOT CAPABILITY

(71) Applicant: Nitin V. Sarangdhar, Portland, OR (US)

(72) Inventor: Nitin V. Sarangdhar, Portland, OR (US)

(21) Appl. No.: 14/581,275

(22) Filed: Dec. 23, 2014

(51) Int. Cl. G06F 21/57

(52) U.S. Cl. CPC G06F 21/575

(57) ABSTRACT

A package with a processing device and integrated cryptographic firmware is described. The package includes a processing device including a processing module to execute a system management mode and a non-volatile memory storing cryptographic firmware to execute one or more cryptographic functions in the system management mode.

### TECHNICAL FIELD

Embodiments described herein generally relate to processing devices and, more specifically, relate to a processing device with measured boot capability.

### BACKGROUND

A processing device may include a measured boot capability in which measurements are taken during a boot-up of the processing device. These measurements can be used by a remote server to establish the trust reputation of the processing device (or the device, such as a sensor, of which the processing device is a part). It may be desirable that such a processing device be made robust against a permanent denial of service attack and be able to quickly recover in case of such an attack.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 is a functional block diagram of a sensor according to an embodiment of the disclosure.

FIG. 2A is a functional block diagram of an SPI Flash according to an embodiment of the disclosure.

FIG. 2B is a functional block diagram of the primary image region of FIG. 2A.

FIG. 2C is a functional block diagram of the secondary image region of FIG. 2A.

FIG. 3A is a flow diagram illustrating a method of booting a processing device according to an embodiment of the disclosure.

FIG. 3B is a flow diagram of an embodiment of a method of initiating read-only memory code execution.

FIG. 3C is a flow diagram of an embodiment of a method of extending an image measurement.

FIG. 3D is a flow diagram of another embodiment of a method of extending an image measurement.

FIG. 3E is a flow diagram of an embodiment of a method of executing runtime software.

FIG. 3F is a flow diagram of another embodiment of a method of executing runtime software.

FIG. 4A is a flow diagram illustrating a method of booting a processing device according to another embodiment of the disclosure.

FIG. 4B is a flow diagram illustrating a method of booting a processing device according to another embodiment of the disclosure.

FIG. 5 is a flow diagram illustrating a method of executing a cryptographic function according to an embodiment of the disclosure.

FIG. 6 is a functional block diagram of a processing device according to an embodiment of the disclosure.

FIG. 7 is a block diagram of a system on chip (SoC), in accordance with an embodiment of the present disclosure.

FIG. 8 is a block diagram of an embodiment of a system on-chip (SoC) design, in accordance with another embodiment of the present disclosure.

FIG. 9 is a block diagram of a computer system, according to one embodiment of the present disclosure.

FIG. 10A is a block diagram illustrating an in-order pipeline and a register renaming stage, out-of-order issue/execution pipeline implemented by a processor core, in accordance with one embodiment of the present disclosure.

FIG. 10B is a block diagram illustrating an in-order architecture core and a register renaming logic, out-of-order issue/execution logic to be included in a processor according to at least one embodiment of the disclosure.

FIG. 11 is a block diagram of the micro-architecture for a processor that includes logic circuits to perform instructions, in accordance with one embodiment of the present invention.

FIG. 12 illustrates a diagrammatic representation of a machine in the example form of a computer system within which a set of instructions, for causing the machine to perform any one or more of the methodologies discussed herein, may be executed.

### DESCRIPTION OF EMBODIMENTS

A processing device may include a measured boot capability in which information generated during the boot-up of the processing device is signed with a cryptographic key and transmitted to a remote server. Such a boot-up process may be referred to as a measured boot or a secure boot. The signed information may be used by the remote server to establish the trust reputation of the processing device and/or subsequent messages transmitted by the processing device to the remote server.

A measured boot capability may be particular important for processing devices used in sensors in an industrial environment, such as, for example, environmental sensors (including temperature sensors or humidity sensors) and proximity sensors.

An industrial environment provides a number of challenges. For example, the sensor may not be readily accessible. Thus, it may be difficult to periodically replace components of the sensor and the environment may not guarantee uninterrupted power to the processing device at all times. Thus, in one embodiment, the processing device may not include a power supply (e.g, a coin-cell battery) that maintains power to volatile memory (e.g., on-chip CMOS SRAM [complementary metal-oxide-semiconductor static random-access memory]). Rather, in one embodiment, the sensor includes non-volatile memory (e.g., SPI [serial peripheral interface] Flash memory) that can support replay protected monotonic counters as described further below.

In an industrial environment, it may be desirable for the sensor to be smaller or include fewer components than in other environments. Thus, in one embodiment, the sensor may not include a discrete TPM [trusted platform module] to generate cryptographic keys. Rather, in one embodiment, the processing device performs the functions of the TPM in firmware. In one embodiment, the processing device provides a trusted execution environment and the TPM is implemented as a trusted application. In larger processing devices, a security engine may provide the trusted execution environment. However, in an industrial environment, where a smaller, die-size-constrained processing device lacking a security engine may be used, a SMM [system management mode] may be used as the trusted execution environment and the TPM may execute as an SMM application as described further below. In the SMM, all normal execution by the processing device, including the operating system, may be suspended and firmware may be executed in a high-privilege mode.

As noted above, a sensor in an industrial environment may not be readily accessible by an operator for repair or replacement. Thus, the sensor may be protected from a permanent denial of service attack and able to quickly recover in case of such an attack. As described further below, the SMM may write protect UEFI (united extensible firmware interface) variables on the memory during runtime. The initialization boot code may also write protect a recovery image by locking it immediately after a reset of the processing device so that is cannot be written during runtime, e.g., by malware or corrupt instructions.

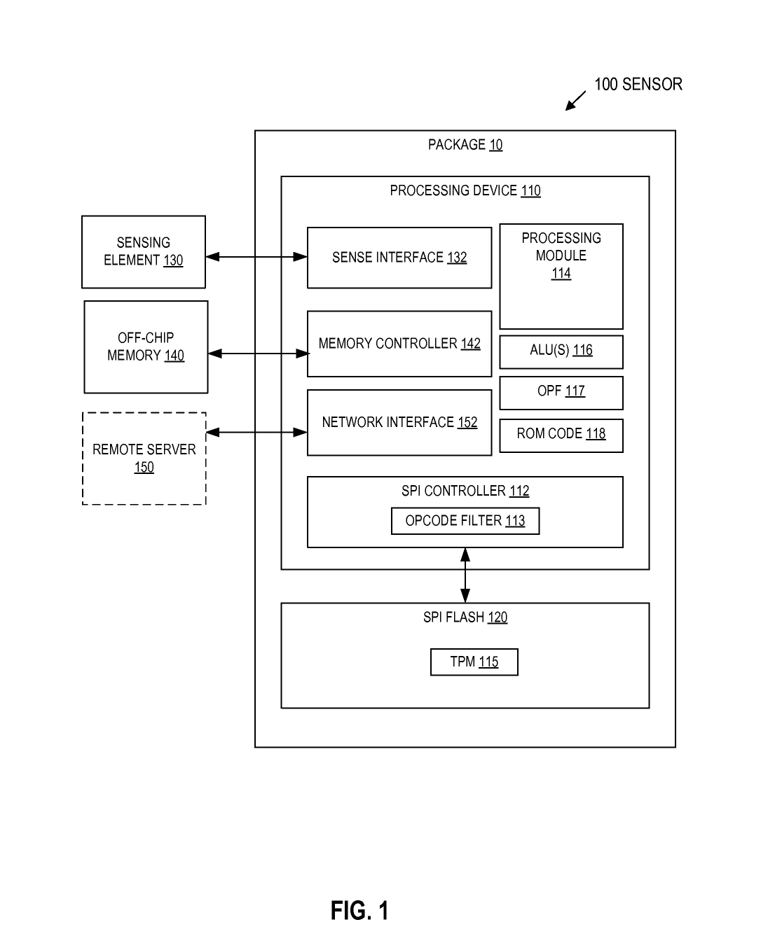

FIG. 1 is a functional block diagram of a sensor 100 according to an embodiment of the disclosure. The sensor 100 includes a sensing element 130 coupled to a package 10 that includes a processing device 110 with a number of components and an SPI (serial peripheral interface) Flash 120. The processing device 110 includes a sensing interface 132 for receiving information from the sensing element 130. The sensing element 130 may be, for example, an environmental sensor such as a temperature sensor, humidity sensor, toxin sensor (e.g, for sensing carbon monoxide levels), or any other type of environmental sensor. The sensing element 130 may a biological sensor such as a blood pressure sensor, heart rate monitor, glucose sensor, or any other type of biological sensor. The sensing element 130 may be a proximity sensor. The sensing element 130 may be any type of sensing device or input device that provides information to the processing device 110.

The sensor 110 also includes an off-chip memory 140 coupled to the processing device 110. The processing device 110 may include a memory controller 142 for reading data from and writing data to the off-chip memory 140. The processing device 110 may include a network interface 152 for transmitting data from and receiving data to the processing device 110. For example, the network interface 152 may be used to transmit data to a remote server 150.

The processing device 110 includes a processing module 114 which enters a system management mode (SMM) when it receives a system management interrupt (SMI). During the SMM, normal execution (including the operating system) by the processing module 114 is suspended and firmware is executed in a high-privilege mode.

The SMM may handle system-wide functions like power management, system hardware control (e.g., memory or chipset errors), OEM (original equipment manufacturer) code, or other functions. The SMM may be used by system firmware and may be inaccessible to application software or general-purpose system software. The SMM may offer a distinct and isolated processing environment that operates separately from the operating system or other software applications.

When in the SMM, the processing module 114 executes trusted platform module (TPM) firmware 115 stored in the SPI Flash 120 for implementing a TPM. In one embodiment, the TPM firmware 115 performs the functions of the TPM rather than generating calls to a discrete TPM separate from the processing device 110. The processing module 114 may be integral with, on the same chip as, other components of the processing device 110, such as the sensing interface 132. Similarly, the processing device 110 may be integral with the SPI Flash 120 or otherwise bound to the SPI Flash 120 during production (e.g., by provisioning identical keys to the processing device 110 and the SPI Flash 120). In another embodiment, the TPM firmware 115 communicates with a discrete TPM (not shown) for implementing the functionality of the TPM.

The TPM firmware 115 may be used to perform a measured boot. During a boot-up process of the processing module 114, the TPM firmware 115 may be executed to store measurements taken (or other information generated) by the processing module 114 during boot-up. The measurements may be signed and transmitted to a remote server to establish the trust reputation of the processing device and/or subsequent messages transmitted by the processing device to the remote server. In one embodiment, the TPM firmware 115 may sign the measurements using a hash of the measurements of the processing device 110 (e.g., during boot-up as part of a secure boot or in response to a request from a remote server). The hash along with the signing key and a key certificate may be sent to the remote server for verification that the sensor 100 is to be trusted.

The TPM firmware 115 provides for the secure generation of cryptographic keys as well as other cryptographic functions. The processing device 110 may include one or more ALUs (arithmetic logic units) 116 to support cryptographic algorithms of the TPM firmware 115. The processing device 110 may also include on-time programmable fuses (OPFs) 117 used to encode or store a unique device identifier. In one embodiment, the OPFs 117 are used to generate a 256-bit device-unique key. The processing device 110 may include ROM (read-only memory) code 118 to derive additional keys from the device identifier. For example, the ROM code 118 may generate a unique endorsement key for use by the TPM firmware 115 or a shared HMAC (hash-based message authentication code) Root key for replay protection as described below.

The TPM firmware 115 may also be used to provide replay protected monotonic counter (RPMC) services. A monotonic counter is a counter which increases its count and does not decrease. Replay protected monotonic counters may be used in a secure computer system to protect valuable assets from replay attacks. These attacks involve an attacker that has physical access to the computer system and can replay prior information on an interface to gain possession of valuable assets. A RPMC may be used, for example, to provide a measurement identifier or a time of a measurement taken by the sensing element 130, or for any other purpose.

The TPM firmware 115 may provide RPMC services in conjunction with an SPI Flash 120 that supports RPMC. An SPI Flash specific 256-bit secret key may be generated based on the OPF 117 device identifier using the ROM code 118. For replay protection, the key is generated on-package by the processing device 110. The same key may also be provisioned on the SPI Flash 120 during platform manufacturing to perform a binding operation.

As noted above, the sensor 100 includes an SPI Flash 120 coupled to the processing device 110. In other embodiments, other Flash memory, other non-volatile memory, or any other memory may be used. The processing device 110 may communicate with the SPI Flash 120 using an SPI controller 112. The SPI controller 112 includes an opcode filter 113, hardware that blocks certain opcodes from being communicated to the SPI Flash 120.

The SPI Flash 120 may support an 8-bit opcode field, providing a total of 256 opcodes. However, for most SPI operations, only a subset of the opcodes are used, such as Read, Write/Program, Sector Erase, ReadID, Read SFDP (serial flash discoverable parameter), and Write Enable. Some opcodes, such as Chip Erase, are not used during normal operation. To prevent a malware attack, such as a permanent denial-of-service (PDOS), on the SPI Flash 120, the Chip Erase operation may be blocked by the opcode filter 113 of the SPI controller 112.

The SPI controller 112 may also write protect a recovery image for the processing device 110. The recovery image may be stored in the SPI Flash 120. If the operating firmware image is corrupted or attacked by malware, the recovery image may be used to restore normal operations.

The SPI Controller 112 may also write protect UEFI (united extensible firmware interface) variables on the SPI Flash 120 from the processing module 114 write operations unless the processing module 114 is in the SMM. Hence, the UEFI variables on the SPI Flash 120 are protected from malicious modification by the operating system or other applications executed by the processing module 114.

During power-on of the processing device 110, a blocked opcode table (e.g., specifying a Chip Erase opcode) is read from a descriptor in the SPI Flash 120 to the SPI controller 112. The SPI controller 112, using hardware such as the opcode filter 113, prevents the blocked opcodes from being transmitted to the SPI Flash 120. Also during power-on of the processing device 110, the processing module 114 runs initialization firmware (which may be stored in the SPI Flash 120). The initialization firmware may reads an address range of the recovery image from a descriptor in the SPI Flash 120 and write protect the recovery image by programming a register in the SPI controller 112. The descriptor including the address range of the recovery image may also be write protected.

In one embodiment, during power-on of the processing device 110, the initialization firmware may program the SPI controller 112 to only allow certain good opcodes (using the opcode filter 113) to be communicated to the SPI Flash 120.

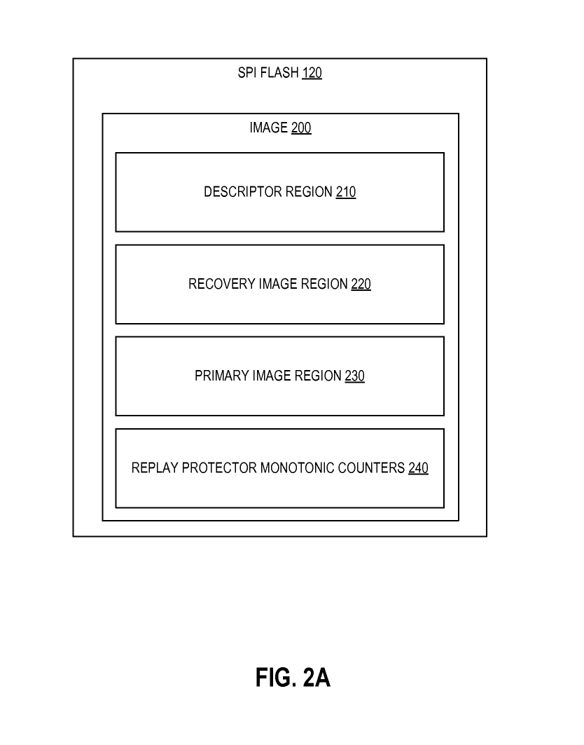

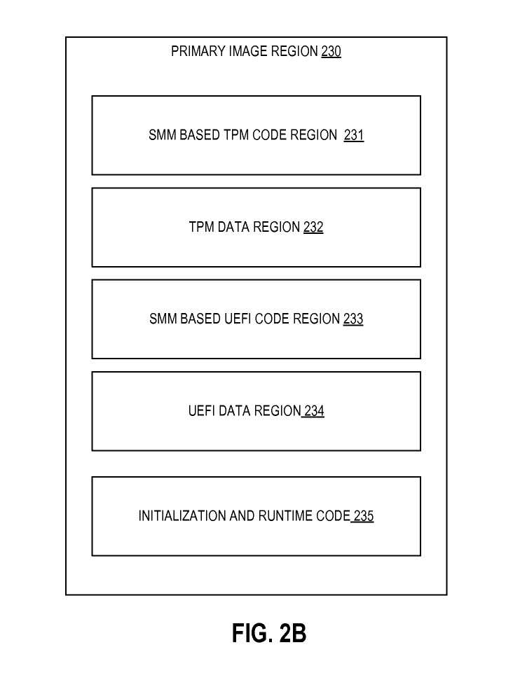

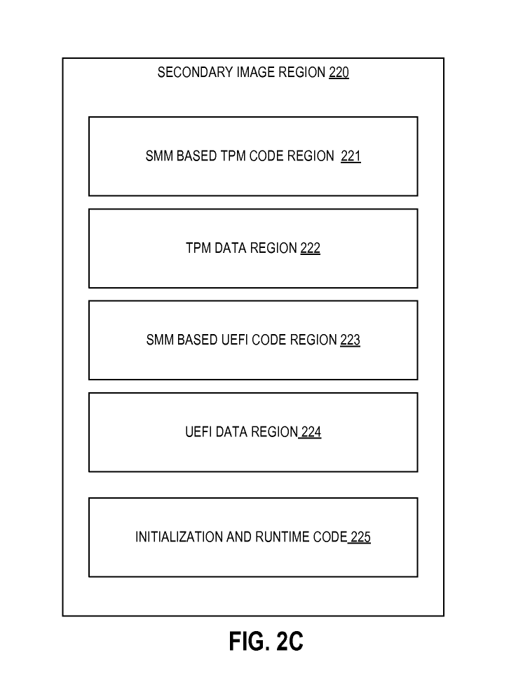

FIG. 2A is a functional block diagram of an SPI Flash 120 according to an embodiment of the disclosure. The SPI Flash 120 stores an image 200 that includes a descriptor region 210 that stores one or more descriptors. The descriptor region 210 may be write protected after reset of the sensor 100. The descriptor region 210 may be write protected by hardware (such as the SMM controller 112) or by secure firmware (such as ROM code). The descriptor region 210 may include address ranges, such as the address range of a recovery image stored in a recovery image region 220. The descriptor region 210 may include an opcode, such as an opcode to be disallowed by the SPI controller 112 using the opcode filter 113 (e.g., a Chip Erase opcode) or an opcode that is to be allowed by the SPI controller 112.

The SPI Flash 120 includes a primary image region 230 that stores a primary image for the 100 and a recovery image region 220 that stores a recovery image for the sensor 100. If the sensor 100 functionality is corrupted or attacked by malware, the recovery image may be used to restore normal operations. The recovery image region 210 may be write protected after reset of the sensor 100. As mentioned above, the recovery image region 210 may be write protected by hardware or by software.

The SPI Flash 120 includes one or more replay protected monotonic counters (RPMC) 240. The RPMC may be accessed by the processing module 114 during SMM with authenticated messages. The RPMC may be used, for example, to provide a measurement identifier (such as a tag) or a time of a measurement taken by the sensing element 130, or for any other purpose.

Thus, the sensor 100 includes at least three levels of data security. The sensor 100 includes a higher level of data security that cannot be modified during power-on firmware execution of the sensor 100. Secure firmware, such as the firmware executed immediately after reset before an operating system starts running or firmware executed in SMM while the operating system is running may be secured at the higher level of data security. The sensor 100 includes a lower level of data security that may be accessed by the operating system or other software executed by the processing device 110. The sensor 100 includes a middle level of data security that may be modified by the processing module 114 during SMM, but not by the operating system or other software executed by the processing device 110. For example, UEFI variables may be secured at the middle level of data security. The sensor 100 may include other levels of data security, such as data that is accessible by the operating system but not by other applications.

FIG. 2B is a functional block diagram of the primary image region 230 of FIG. 2A. The primary image region 230 includes TPM firmware comprising an SMM based TPM code region 231 and a TPM data region 232. The processing module 114 may execute the TPM firmware in the SMM to perform the functions of a TPM. The primary image region 230 also includes UEFI firmware comprising an SMM based UEFI code region 223 and an UEFI data region 234. The processing module 114 may execute the UEFI firmware in the SMM to provide UEFI runtime variable support. The primary image region 230 also includes initialization and runtime code 235. The primary image region 230 may include other information.

FIG. 2C is a functional block diagram of the secondary image region 220 of FIG. 2A. Like the primary image region, the secondary image region 230 includes (1) TPM firmware comprising an SMM based TPM code region 221 and a TPM data region 232, (2) UEFI firmware comprising an SMM based UEFI code region 223 and a UEFI data region 224, and (4) initialization and runtime code 225. The secondary image region 220 may include other information. The secondary image region 220 may be a copy of the primary image region 230 that may replace the primary image region 230 if the primary image region is corrupted or maliciously modified.

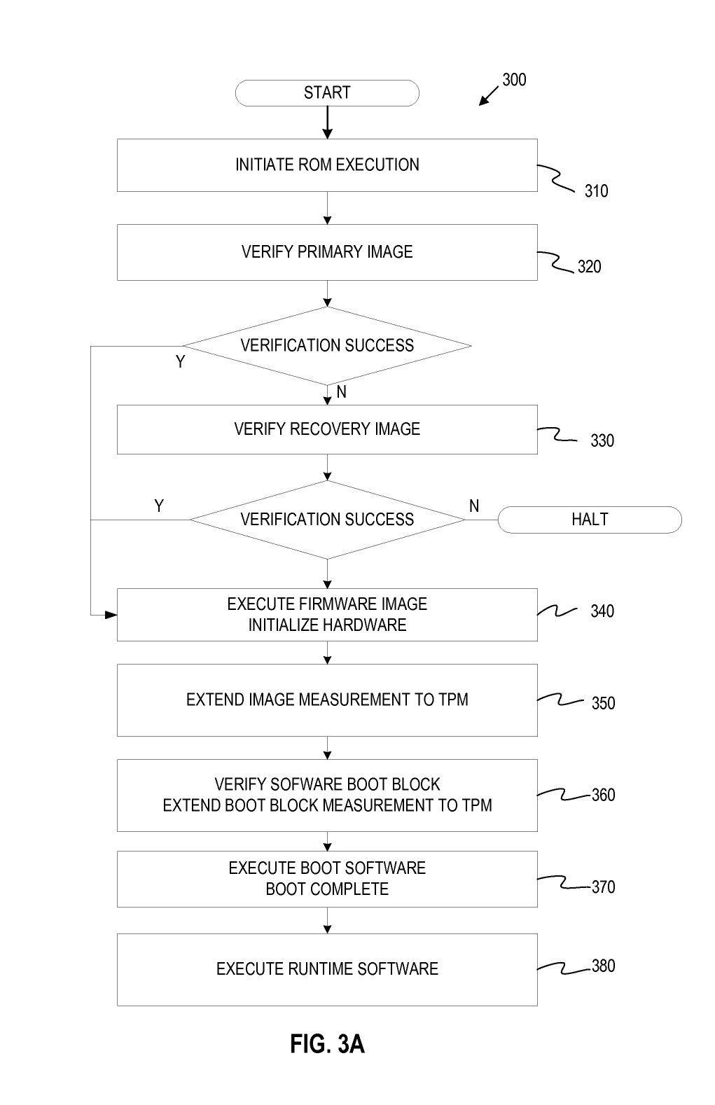

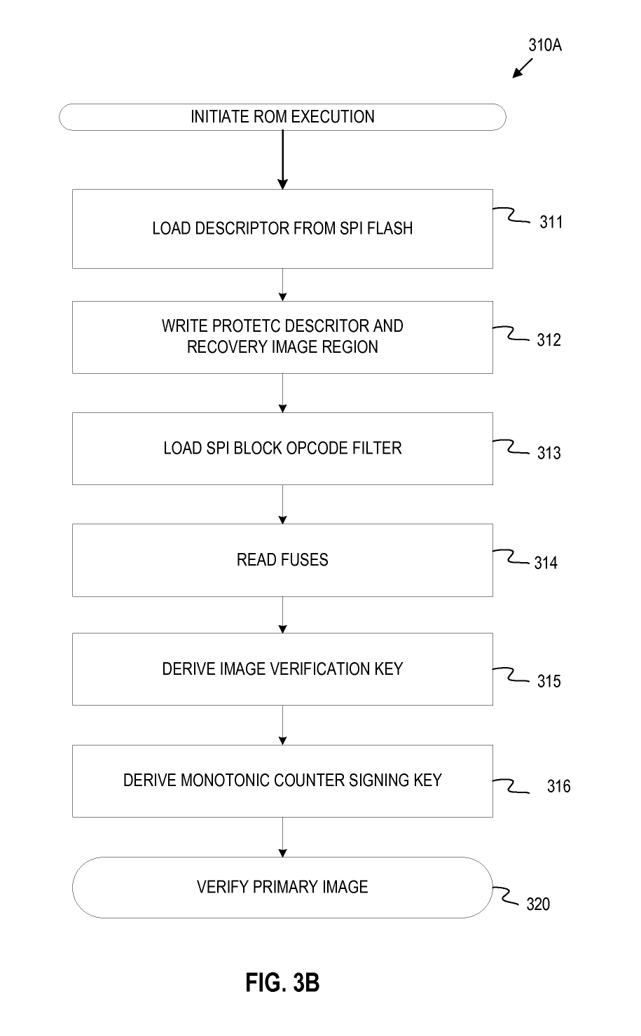

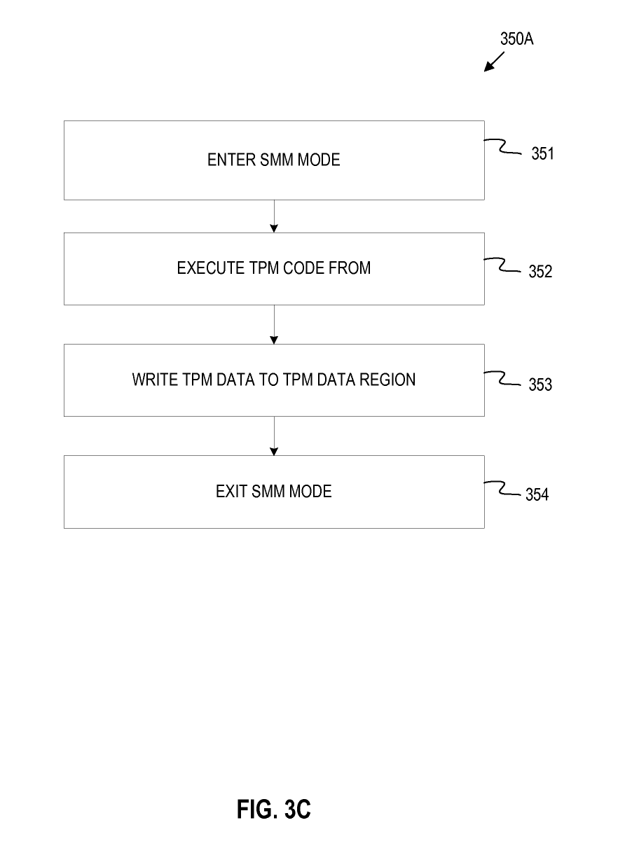

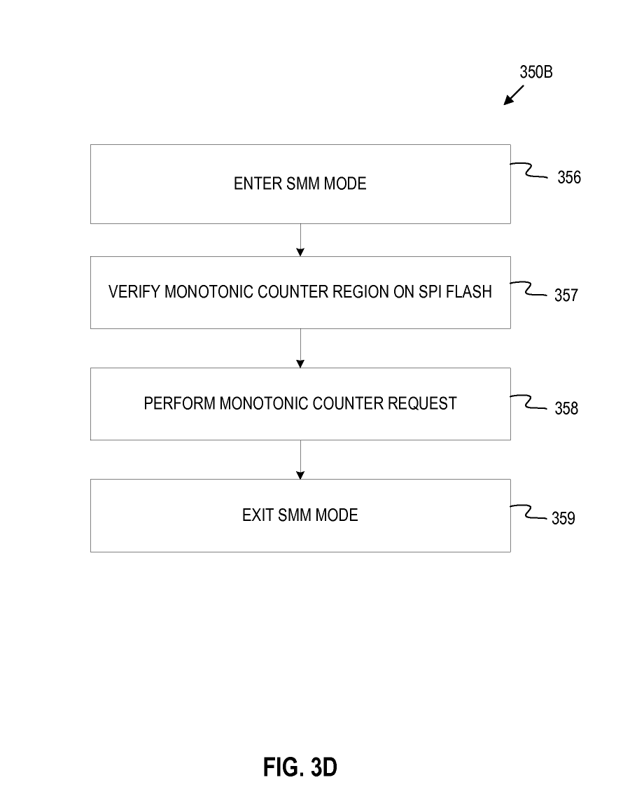

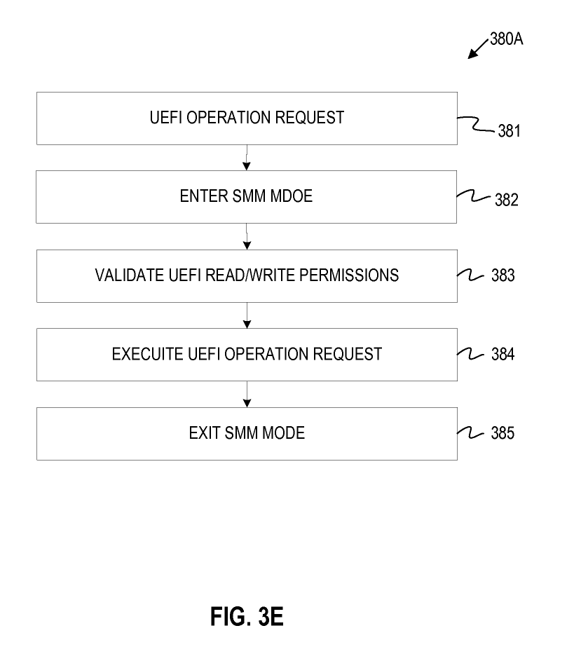

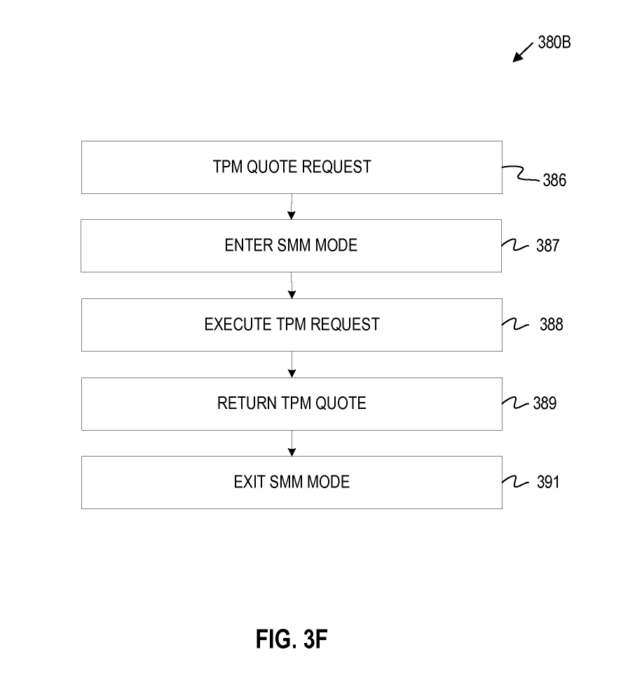

FIG. 3A is a flow diagram illustrating a method 300 of booting a processing device according to an embodiment of the disclosure. The method 300 may be performed by processing logic that may include hardware (e.g., circuitry, dedicated logic, programmable logic, microcode, etc.), software (e.g., instructions executed by a processing device), firmware or a combination thereof. For example, the method 300 may be performed by the processing device 110 of FIG. 1.

The method 300 begins at block 310 with the processing logic initiating a boot-up process using ROM code, such as ROM code 118 of FIG. 1. The processing logic may initiate the boot-up process in response to receiving power to the processing device. The processing logic may initiate the boot-up process in response to receiving a reset command or in response to loading a recovery image from a memory.

At block 320, the processing logic may load a primary image region (such as primary image region 230 of FIG. 2B) and verify a signature of the primary image region using an image verification key. If the verification passes, the method 300 continues to block 340. If the verification, fails the method 300 proceeds to block 330.

At block 330, the processing logic may load the recovery image region (such as recovery image region 220 of FIG. 2C) and verify a signature of the secondary image region using the image verification key. If the verification passes, the method 300 continues to block 340. If the verification fails, this may be an indication of a catastrophic failure and the method 300 halts.

At block 340, the processing logic may execute the verified firmware image (either the primary image region or the secondary image region). The code execution may include hardware initialization. The code execution may also include deleting the image verification key so it is not accessible after hardware initialization.

At block 350, the processing logic may extend an image measurement to TPM firmware. An “extend” operation is a write operation that takes into account the original value of the data which is being written to. In another embodiment, the processing logic may read a data value from the TPM firmware, generate a modified data value based on the image measurement, and write the modified data value to the TPM firmware.

At block 360, the processing logic may end the firmware initialization process by loading a software boot block. The processing logic may verify a software boot block signature against keys provisioned in the verified firmware image and extend the measurements to the TPM firmware. On successful verification, the method 300 continues to block 370, where the processing logic executes boot software completing the boot-up process. Post boot-up, the processing logic may execute, in block 290, runtime software.

FIG. 3B is a flow diagram of an embodiment of a method 310A of execution of block 310 of FIG. 3A. At block 311, the processing logic loads a descriptor region from an SPI Flash, such as the descriptor region 210 of SPI Flash 120 of FIG. 2A. At block 312, the processing logic write protects the descriptor region and a recovery image region (such as recovery image region 220 of FIG. 2A). At block 313, the processing logic loads one or more blocked opcodes into an opcode filter of an SPI controller (such as the opcode filter 113 of SPI controller 112 of FIG. 1).

At block 314, the processing logic reads fuses that are only accessible to the ROM code. For example, the processing logic may read a set of one-time programmable fuses such as the OPF 117 of FIG. 1. At block 315, the processing logic derives an image verification key that may be used for image verification as described above with respect to block 320 and 330 of FIG. 3A. As described above, the image verification key may later be deleted such that the image verification key is only accessible during initialization.

At block 316, the processing logic derives a monotonic counter signing key that may be used to perform monotonic counter operations. In one embodiment, the monotonic counter signing key is stored on-chip in a location that is only accessible as a read-only variable in SMM mode.

FIG. 3C is a flow diagram of an embodiment of a method 350A of execution of block 350 of FIG. 3A. At block 351, the processing logic enters SMM. The processing logic may enter in the system management mode by generating a system management interrupt. In the system management mode, normal execution (including execution of the operating system or other software) is suspended and firmware may be executed in a high-privilege mode. The processing logic may include a flag set to a particular value (e.g., ‘1’) to indicate that the processing logic is in the system management mode.

At block 352, the processing logic executes TPM code. The TPM code may be stored on an SPI Flash of the processing logic or on-package with the processing logic. The TPM code may be stored in a TPM code region of a primary image region or a secondary image region, such as the TPM code 231 of FIG. 2B or the TPM code 221 of FIG. 2C.

At block 353, the processing logic writes TPM data to a TPM data region, such as the TPM data region 232 of FIG. 2B or the TPM data region 222 of FIG. 2C. At block 354, the processing logic exits SMM and the TPM extend operation is complete.

FIG. 3D is a flow diagram of another embodiment of a method 350B of execution of block 350 of FIG. 3A. At block 356, the processing logic enters SMM. At block 357, the processing logic executes cryptographic operations to generate a well-formed SPI Flash monotonic counter region request, e.g., verifying the monotonic counter region on the SPI Flash. This operation may include the use of a monotonic counter signing key as described above that is known only to the processing logic in SMM mode.

At block 358, the processing logic performs the monotonic counter operation through the SPI controller to a SPI Flash monotonic counter region 240, such as the RPMC 240 of FIG. 2A. At block 359, the processing logic exits SMM and the RPMC operation is complete.

FIG. 3E is a flow diagram of an embodiment of a method 380A of execution of block 380 of FIG. 3A. At block 381, the processing logic processes a UEFI operation request and, at block 382, the processing logic enters SMM.

At block 383, the processing logic validates the UEFI read/write permission. Such operation may include verification of authenticated variable signatures or verification of whether a particular UEFI variable is allowed to be read or written in a particular state.

At block 384, in response to the validation, the processing logic executes the UEFI operation. Such operation may include actually writing to (e.g., modifying) an UEFI data region (such as UEFI data region 234 of FIG. 2B or UEFI data region 224 of FIG. 2C).

At block 385, the processing logic exits SMM, thus completing the UEFI operation.

FIG. 3F is a flow diagram of another embodiment of a method 380B of execution of block 380 of FIG. 3A. At block 386, the processing logic processes a TPM quote request. A TPM quote request may be a request to perform a TPM operation in which a public key is provided and a value is returned signed with a private key in a TPM quote format.

At block 388, the processing logic enters SMM mode and, at block 388, the processing logic executes the TPM quote request. Thus operation may include reading the previously stored measurements in a TPM data region and performing cryptographic operations to generate a valid quote.

At block 389, the processing logic returns the TPM quote to the requesting entity and, at block 391, exits SMM, completing the TPM operation.

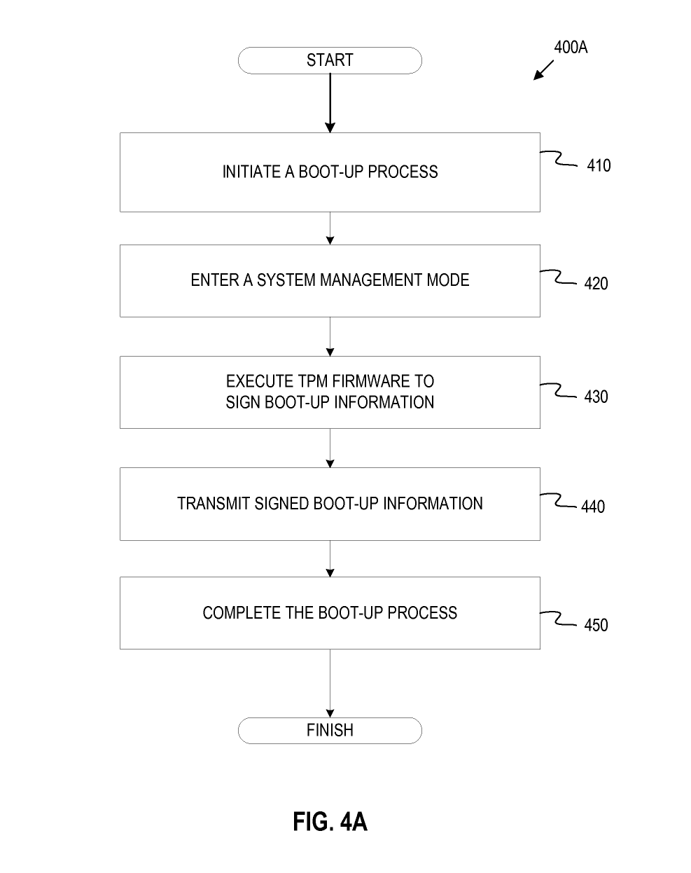

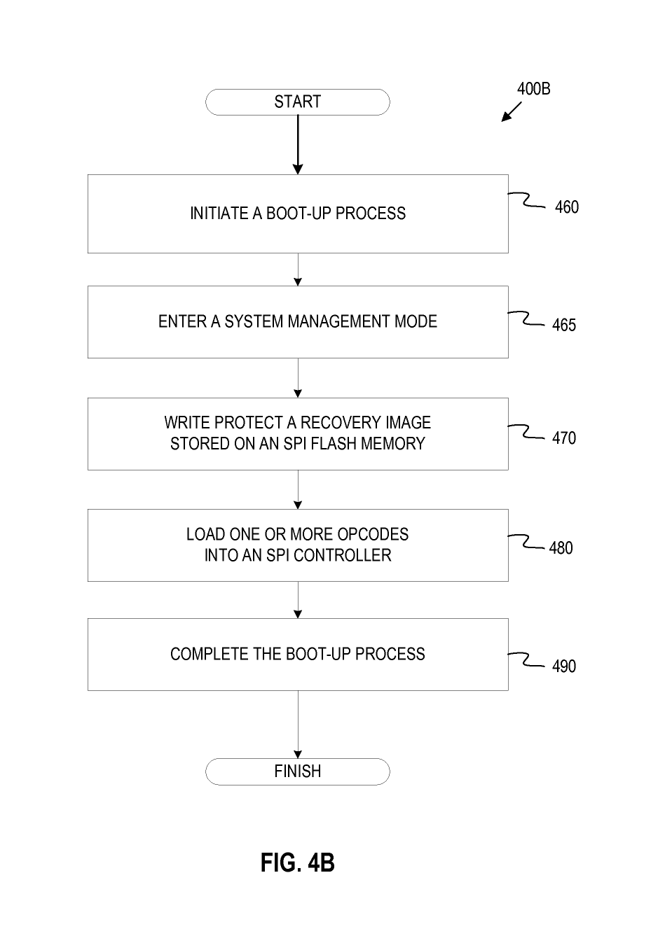

FIG. 4A is a flow diagram illustrating a method 400A of booting a processing device according to another embodiment of the disclosure. The method 400 begins at block 410 with the processing logic initiating a boot-up process. The processing logic may initiate the boot-up process in response to receiving power to the processing device. The processing logic may initiate the boot-up process in response to receiving a reset command or in response to loading a recovery image from a memory.

At block 420, the processing logic enters a system management mode (SMM). The processing logic may enter in the system management mode by generating a system management interrupt. In the system management mode, normal execution (including execution of the operating system or other software) is suspended and firmware may be executed in a high-privilege mode. The processing logic may include a flag set to a particular value (e.g., ‘1’) to indicate that the processing logic is in the system management mode.

At block 430, the processing logic executes trusted platform module (TPM) firmware to sign boot-up information. The TPM firmware may include a TPM code region and a TPM data region. The TPM firmware may be stored in a non-volatile memory that is part of the processing logic or otherwise integrated with the processing logic. For example, the TPM firmware may be stored on an SPI Flash on-package with a processing device. The non-volatile memory may be bound to the processing device by one or more keys during production. The boot-up information may include data generated during the boot-up process. For example, the boot-up information may include a hardware and/or software configuration of the processing device. The boot-up information may include measurements taken during the boot-up process.

The TPM firmware may sign the boot-up information using a cryptographic algorithm. For example, the TPM firmware may cryptographically sign the boot-up information. In one embodiment, the TPM firmware signs the boot-up information with a cryptographic certificate including a hash of the boot-up information. The TPM firmware may sign the boot-up information with a key derived from a set of one-time programmable fuses of the processing device. In particular, the processing logic may use read-only memory code of the processing device to generate the key based on a device identifier encoded by the set of one-time programmable fuses.

At block 440, the processing logic transmits the signed boot-up information to a remote server. The signed boot-up information may be used by the remote server to establish the trust reputation of the processing device and/or subsequent messages transmitted by the processing device to the remote server.

At block 440, the processing logic completes the boot-up process. Completing the boot-up process may include write protecting, while in the system management mode, a recovery image for the processing device. Completing the boot-up process may include loading, while in the system management mode, one or more opcodes into an opcode filter of the processing device. The opcode filter may include hardware that prevents a memory controller of the processing device from issuing the one or more opcodes to a memory. Alternatively, the opcode filter may include hardware that allows the memory controller to only issue the one or more opcodes to the memory. Completing the boot-up process may also include exiting the system management mode and executing an operating system.

FIG. 4B is a flow diagram illustrating a method 400B of booting a processing device according to another embodiment of the disclosure. The method 400B may be performed by processing logic that may include hardware (e.g., circuitry, dedicated logic, programmable logic, microcode, etc.), software (e.g., instructions executed by a processing device), firmware or a combination thereof. For example, the method 400 may be performed by the processing device 110 of FIG. 1.

The method 400B begins at block 460 with processing logic initiating a boot-up process. The processing logic may initiate the boot-up process in response to receiving power to the processing device. The processing logic may initiate the boot-up process in response to receiving a reset command or in response to loading a recovery image from a memory.

At block 465, the processing logic places the processing device in a system management mode and the processing device enters the system management mode. The processing logic may place the processing device in the system management mode by generating a system management interrupt. In the system management mode, normal execution (including execution of the operating system or other software) by the processing device is suspended. In the system management mode, firmware may be executed in a high-privilege mode. The processing logic may include a flag set to a particular value (e.g., ‘1’) to indicate that the processing device is in the system management mode.

At block 470, the processing logic write protects a recovery image stored on a serial peripheral interface (SPI) Flash memory. The processing logic may read an address range for the recovery image from a first descriptor of the SPI Flash memory and write protect the address range indicated by the first descriptor. The processing logic may also write protect the first descriptor.

At block 480, the processing logic loads one or more opcodes into a SPI controller. The processing logic may read the one or more opcodes from a second descriptor of the SPI Flash memory. In one embodiment, the processing logic (such as the SMM module 114 of FIG. 1) loads a Chip Erase opcode from a descriptor in the SPI Flash memory. The SPI controller, using hardware such as an opcode filter, prevents the Chip Erase opcode from being transmitted to the SPI Flash. In another embodiment, the processing logic (such as software) programs the SPI controller to only allow certain opcodes (using the opcode filter) to be communicated to the SPI Flash. The processing logic may also write protect the second descriptor.

At block 490, the processing logic completes the boot-up process. Completing the boot-up process may involve additional steps as described above with respect to the method 300 of FIG. 3A or the method 400A of FIG. 4A.

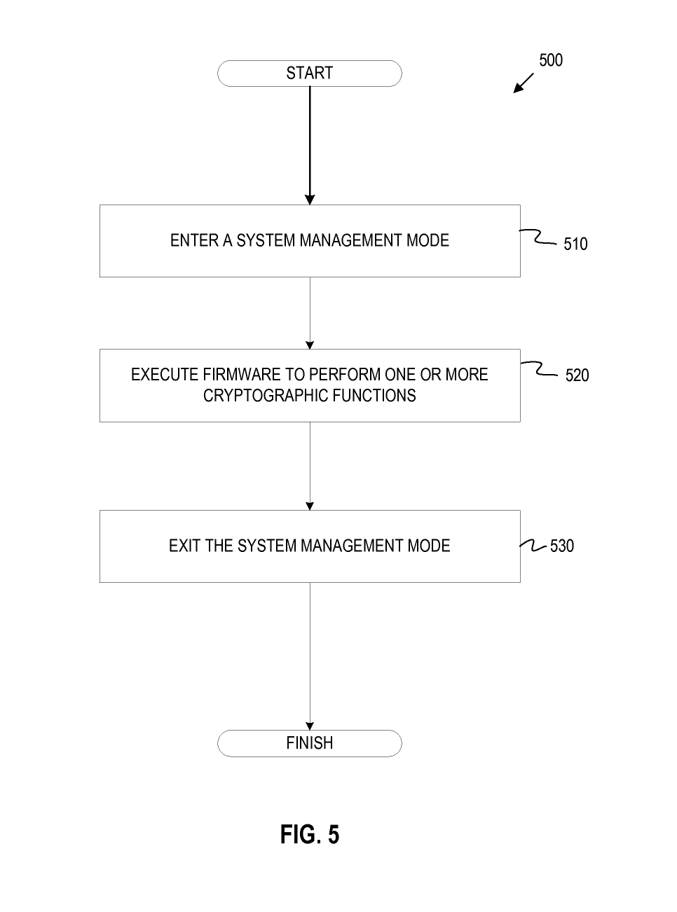

FIG. 5 is a flow diagram illustrating a method 500 of executing a cryptographic function, according to an embodiment of the disclosure. The method 500 may be performed by processing logic that may include hardware (e.g., circuitry, dedicated logic, programmable logic, microcode, etc.), software (e.g., instructions executed by a processing device), firmware or a combination thereof. For example, the method 500 may be performed by the processing device 110 of FIG. 1.

The method 500 begins at block 510 with processing logic entering a system management mode. The processing logic may place a processing device in the system management mode by generating a system management interrupt. In the system management mode, normal execution (including execution of the operating system or other software) by the processing device is suspended. In the system management mode, firmware may be executed in a high-privilege mode. The processing logic may include a flag set to a particular value (e.g., ‘1’) to indicate that the processing device is in the system management mode.

At block 520, the processing logic executes firmware to perform one or more cryptographic functions. The firmware may include trusted platform module (TPM) firmware for executing the functions of a trusted platform module. The one or more cryptographic functions may include cryptographically signing data, such as data generating during a boot-up process. The one or more cryptographic functions may include calling a replay protected monotonic counter stored on a memory, such as an SPI Flash memory.

The one or more cryptographic functions may be performed using at least one cryptographic key. The cryptographic key may be based on a device identifier encoded by a set of one-time programmable fuses. For example, the one or more cryptographic functions may include transmitting an SPI Flash key based on a device identifier encoded by a set of one-time programmable fuses.

At block 530, the processing logic exits the system management mode. Thus, execution of an operating system or other software may be performed by the processing logic.

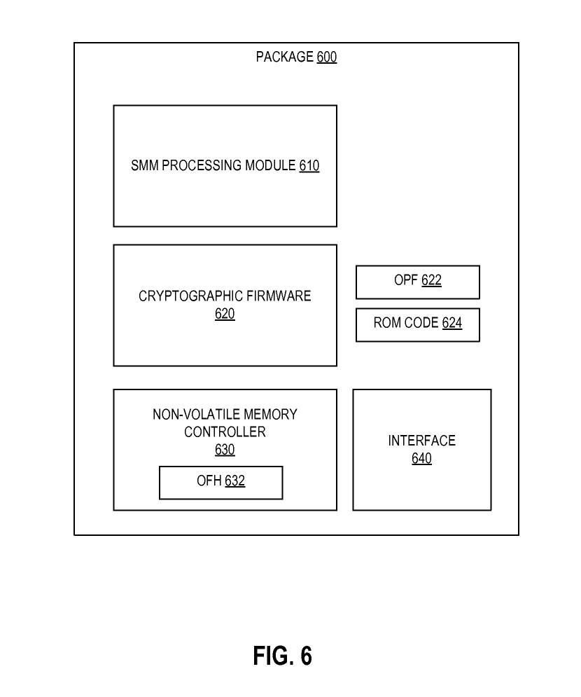

FIG. 6 is a functional block diagram of a package 600. The processing device 600 includes a system management mode (SMM) processing module 610 that executes in a system management mode. The package 600 further includes cryptographic firmware 620 to execute one or more cryptographic functions while the processing module 610 is in the system management mode.

In one embodiment, the processing module 610 is to execute the cryptographic firmware 620 during a boot-up of the package 600 (or a portion thereof) to cryptographically sign data generated during the boot-up. The package 600 may further include an interface 640 (such as a network interface) to transmit the cryptographically signed data to a remote server.

The package 600 may include a set of one-time programmable fuses 622 to encode or store a device identifier of the package 600 and read-only-memory code 624 to generate one or more cryptographic keys based on the device identifier. In one embodiment, the cryptographic firmware 620 is to execute one or more cryptographic functions in the system management mode using at least one of the cryptographic keys.

The package 600 may include a non-volatile memory controller 630 to interface with a non-volatile memory which may be part of the package 600 and store the cryptographic firmware 620. For example, the package 600 may include a serial peripheral interface (SPI) controller for interfacing with an SPI Flash memory of the package 600. The non-volatile memory controller 630 may include opcode filtering hardware (OFH) 632 that prevents the non-volatile memory controller 632 from issuing a subset of opcodes to the non-volatile memory. For example, the OFH may include a list of opcodes that cannot be issued to the non-volatile memory or may include a list of opcodes that can exclusively be issued to the non-volatile memory.

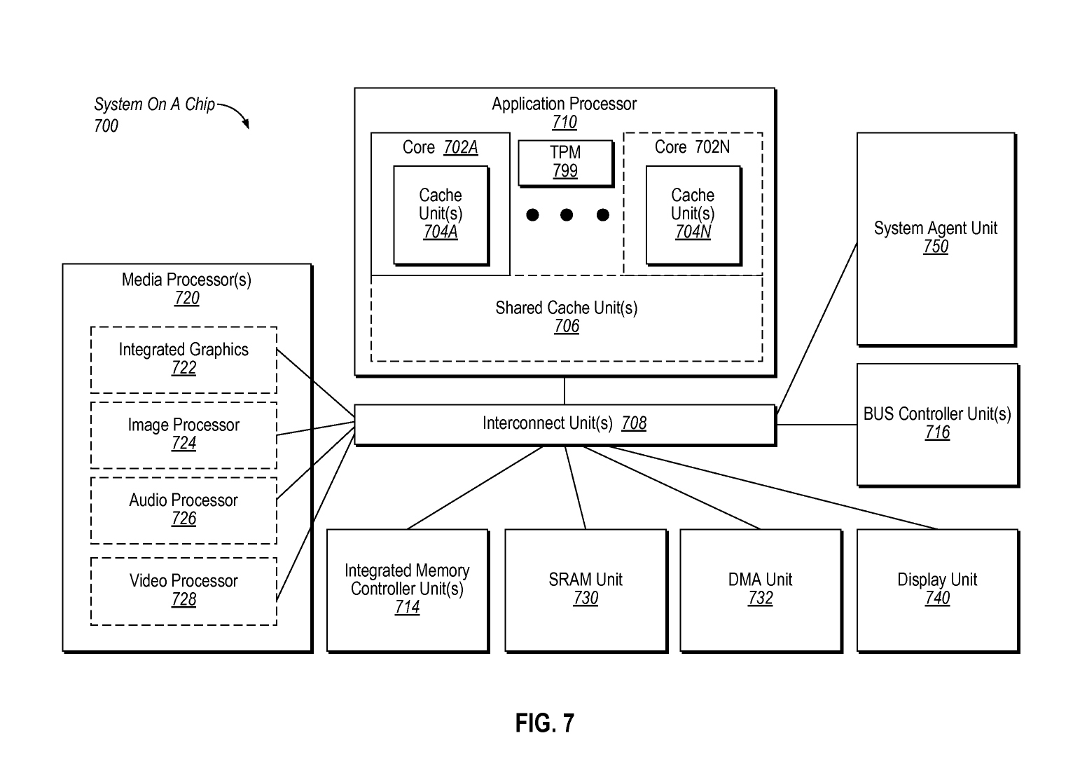

FIG. 7 is a block diagram of a SoC 700 in accordance with an embodiment of the present disclosure. Dashed lined boxes are optional features on more advanced SoCs. In FIG. 7, an interconnect unit(s) 708 is coupled to: an application processor 710 which includes a set of one or more cores 702A-702N and shared cache unit(s) 706; a system agent unit 750; a bus controller unit(s) 716; an integrated memory controller unit(s) 714; a set of one or more media processors 720 which may include integrated graphics logic 722, an image processor 724 for providing still and/or video camera functionality, an audio processor 726 for providing hardware audio acceleration, and a video processor 728 for providing video encode/decode acceleration; an static random access memory (SRAM) unit 730; a direct memory access (DMA) unit 732; and a display unit 740 for coupling to one or more external displays. In one embodiment, the application processor 710 includes the processing device 110 of FIG. 1. The application processor 710 includes TPM firmware 799 which may correspond to the TPM firmware 115 of FIG. 1.

The memory hierarchy includes one or more levels of cache within the cores, a set or one or more shared cache units 706, and external memory (not shown) coupled to the set of integrated memory controller units 714. The set of shared cache units 706 may include one or more mid-level caches, such as level 2 (L2), level 3 (L3), level 4 (L4), or other levels of cache, a last level cache (LLC), and/or combinations thereof.

In some embodiments, one or more of the cores 702A-702N are capable of multithreading.

The system agent 750 includes those components coordinating and operating cores 702A-702N. The system agent unit 750 may include for example a power control unit (PCU) and a display unit. The PCU may be or include logic and components needed for regulating the power state of the cores 702A-702N and the integrated graphics logic 708. The display unit 740 is for driving one or more externally connected displays.

The cores 702A-702N may be homogenous or heterogeneous in terms of architecture and/or instruction set. For example, some of the cores 702A-702N may be in order while others are out-of-order. As another example, two or more of the cores 702A-702N may be capable of execution of the same instruction set, while others may be capable of executing only a subset of that instruction set or a different instruction set.

The application processor 710 may be a general-purpose processor, such as a Core™ i3, i5, i7, 2 Duo and Quad, Xeon™, Xeon-Phi™, Itanium™, XScale™ or StrongARM™ processor, which are available from Intel Corporation, of Santa Clara, Calif. Alternatively, the application processor 710 may be from another company, such as ARM Holdings, Ltd, MIPS, etc. The application processor 710 may be a special-purpose processor, such as, for example, a network or communication processor, compression engine, graphics processor, co-processor, embedded processor, or the like. The application processor 710 may be implemented on one or more chips. The application processor 710 may be a part of and/or may be implemented on one or more substrates using any of a number of process technologies, such as, for example, BiCMOS, CMOS, or NMOS.

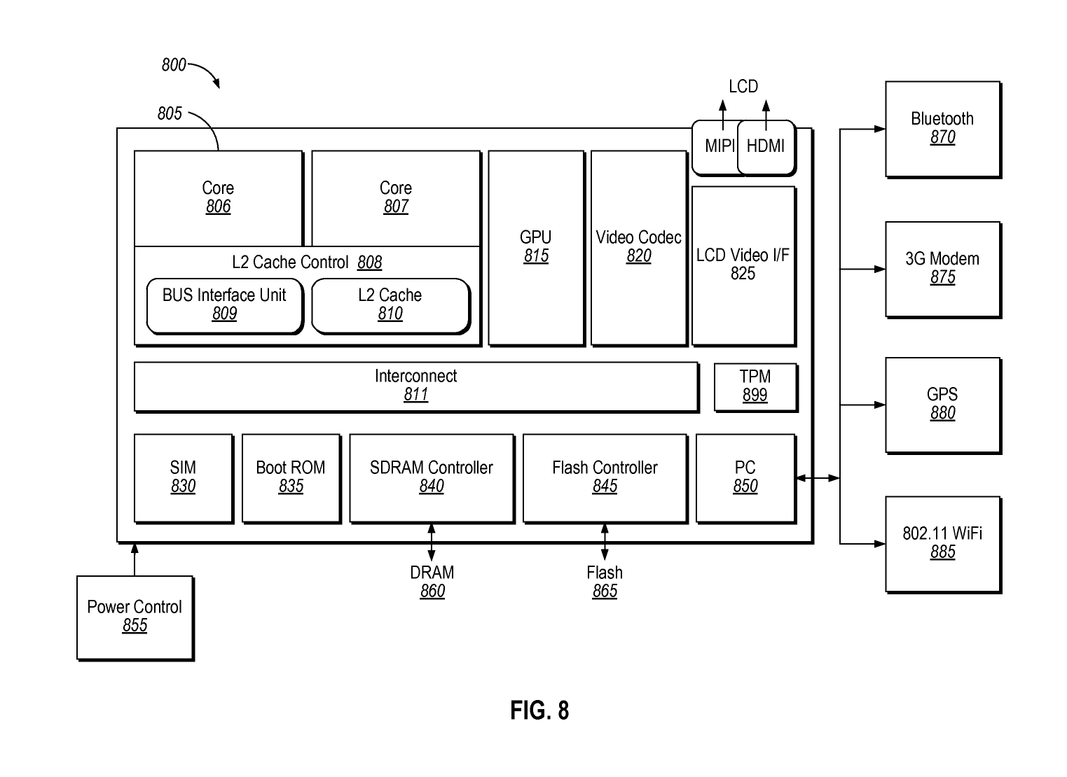

FIG. 8 is a block diagram of an embodiment of a system on-chip (SOC) design in accordance with the present disclosure. As a specific illustrative example, SOC 800 is included in user equipment (UE). In one embodiment, UE refers to any device to be used by an end-user to communicate, such as a hand-held phone, smartphone, tablet, ultra-thin notebook, notebook with broadband adapter, or any other similar communication device. Often a UE connects to a base station or node, which potentially corresponds in nature to a mobile station (MS) in a GSM network. In one embodiment, the SOC 800 may include the processing device 110 of FIG. 1. The SOC 800 includes TPM firmware 899 which may correspond to the TPM firmware 115 of FIG. 1.

Here, SOC 800 includes 2 cores—806 and 807. Cores 806 and 807 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 806 and 807 are coupled to cache control 808 that is associated with bus interface unit 809 and L2 cache 810 to communicate with other parts of system 800. Interconnect 811 includes an on-chip interconnect, such as an IOSF, AMBA, or other interconnect discussed above, which potentially implements one or more aspects of the described disclosure.

Interface 811 provides communication channels to the other components, such as a Subscriber Identity Module (SIM) 830 to interface with a SIM card, a boot ROM 835 to hold boot code for execution by cores 806 and 807 to initialize and boot SOC 800, a SDRAM controller 840 to interface with external memory (e.g. DRAM 860), a flash controller 845 to interface with non-volatile memory (e.g. Flash 865), a peripheral control 850 (e.g. Serial Peripheral Interface) to interface with peripherals, video codecs 820 and Video interface 825 to display and receive input (e.g. touch enabled input), GPU 815 to perform graphics related computations, etc. Any of these interfaces may incorporate aspects of the disclosure described herein.

In addition, the system 800 illustrates peripherals for communication, such as a Bluetooth module 870, 3G modem 875, GPS 880, and Wi-Fi 885. Note as stated above, a UE includes a radio for communication. As a result, these peripheral communication modules are not all required. However, in a UE, some form a radio for external communication is to be included.

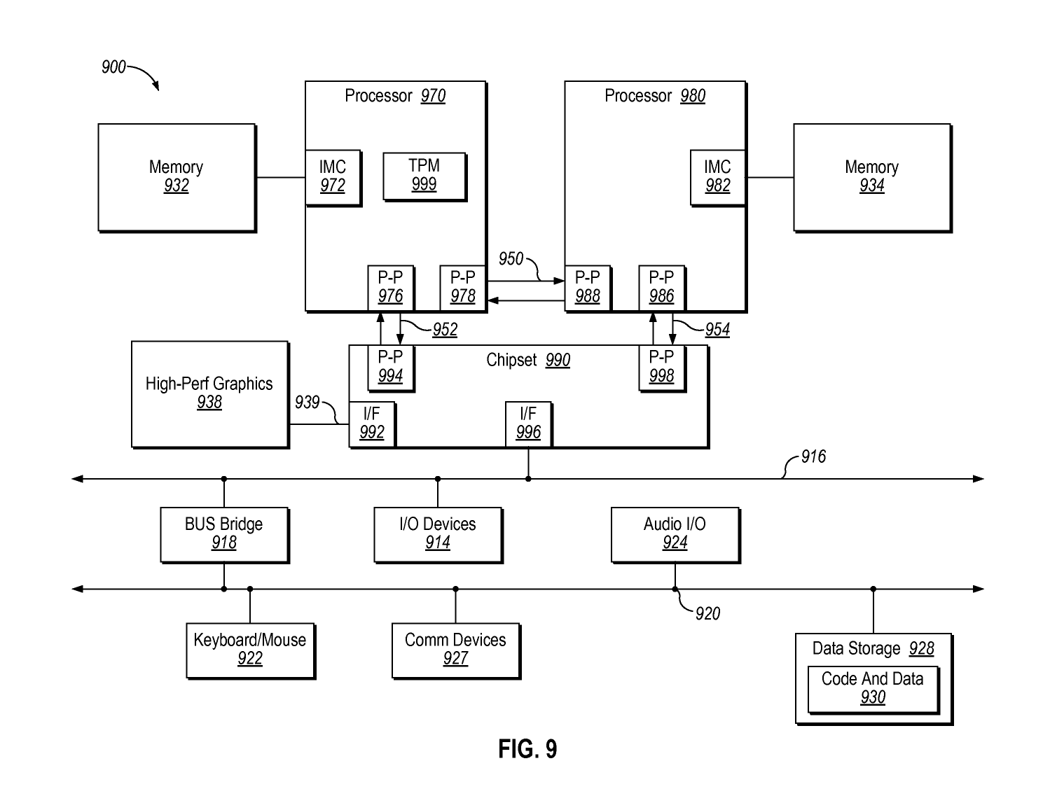

FIG. 9 is a block diagram of a multiprocessor system 900 in accordance with an implementation. As shown in FIG. 9, multiprocessor system 900 is a point-to-point interconnect system, and includes a first processor 970 and a second processor 980 coupled via a point-to-point interconnect 950. Each of processors 970 and 980 may be some version of the processing device 110 of FIG. 1. The processor 970 includes TPM firmware 999 which may correspond to the TPM firmware 115 of FIG. 1. As shown in FIG. 9, each of processors 970 and 980 may be multicore processors, including first and second processor cores, although potentially many more cores may be present in the processors. A processor core may also be referred to as an execution core.

While shown with two processors 970, 980, it is to be understood that the scope of the present disclosure is not so limited. In other implementations, one or more additional processors may be present in a given processor.

Processors 970 and 980 are shown including integrated memory controller units 972 and 982, respectively. Processor 970 also includes as part of its bus controller units point-to-point (P-P) interfaces 976 and 978; similarly, second processor 980 includes P-P interfaces 986 and 988. Processors 970, 980 may exchange information via a point-to-point (P-P) interface 950 using P-P interface circuits 978, 988. As shown in FIG. 9, IMCs 972 and 982 couple the processors to respective memories, namely a memory 932 and a memory 934, which may be portions of main memory locally attached to the respective processors.

Processors 970, 980 may each exchange information with a chipset 990 via individual P-P interfaces 952, 954 using point to point interface circuits 976, 994, 986, and 998. Chipset 990 may also exchange information with a high-performance graphics circuit 938 via a high-performance graphics interface 939.

A shared cache (not shown) may be included in either processor or outside of both processors, yet connected with the processors via P-P interconnect, such that either or both processors' local cache information may be stored in the shared cache if a processor is placed into a low power mode.

Chipset 990 may be coupled to a first bus 916 via an interface 996. In one embodiment, first bus 916 may be a Peripheral Component Interconnect (PCI) bus, or a bus such as a PCI Express bus or another third generation I/O interconnect bus, although the scope of the present disclosure is not so limited.

As shown in FIG. 9, various I/O devices 914 may be coupled to first bus 916, along with a bus bridge 918 which couples first bus 916 to a second bus 920. In one embodiment, second bus 920 may be a low pin count (LPC) bus. Various devices may be coupled to second bus 920 including, for example, a keyboard and/or mouse 922, communication devices 927 and a storage unit 928 such as a disk drive or other mass storage device which may include instructions/code and data 930, in one embodiment. Further, an audio I/O 924 may be coupled to second bus 920. Note that other architectures are possible. For example, instead of the point-to-point architecture of FIG. 9, a system may implement a multi-drop bus or other such architecture.

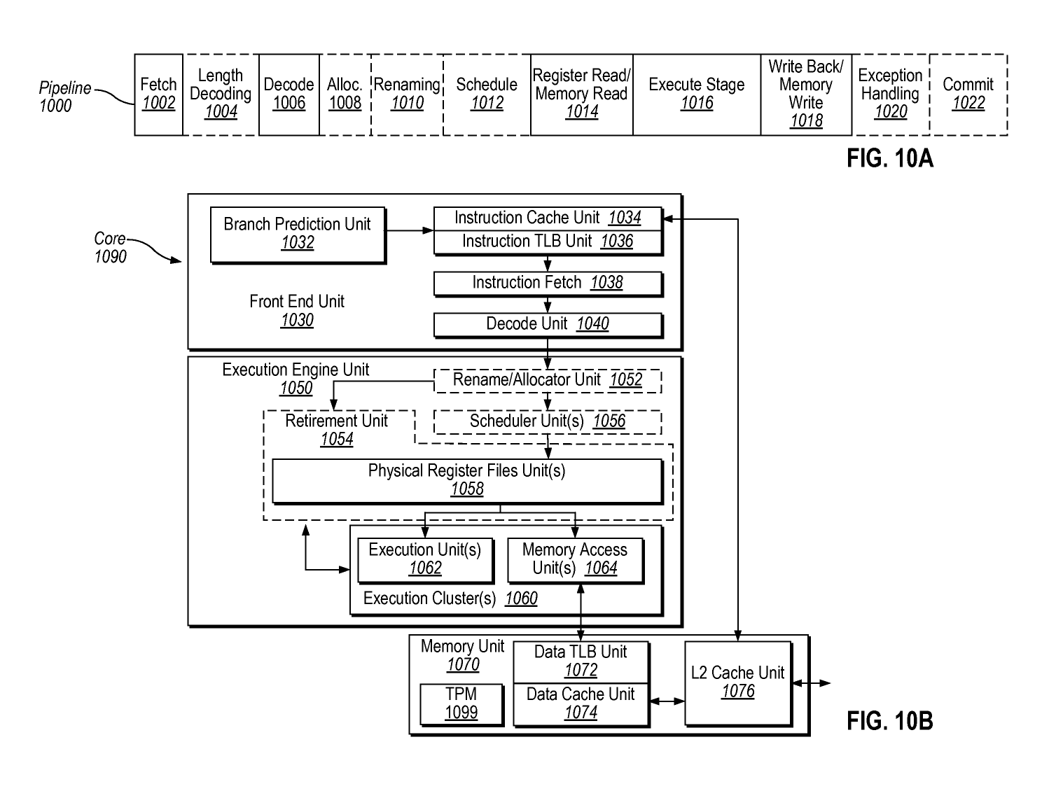

FIG. 10A is a block diagram illustrating an in-order pipeline and a register renaming stage, out-of-order issue/execution pipeline implemented by core 1090 of FIG. 10B (which may be include in a processor). FIG. 10B is a block diagram illustrating an in-order architecture core and a register renaming logic, out-of-order issue/execution logic that may be included in a processor according to at least one embodiment of the invention. The solid lined boxes in FIG. 10A illustrate the in-order pipeline, while the dashed lined boxes illustrates the register renaming, out-of-order issue/execution pipeline. Similarly, the solid lined boxes in FIG. 10A illustrate the in-order architecture logic, while the dashed lined boxes illustrates the register renaming logic and out-of-order issue/execution logic. In FIG. 10A, a processor pipeline 1000 includes a fetch stage 1002, a length decode stage 1004, a decode stage 1006, an allocation stage 1008, a renaming stage 1010, a scheduling (also known as a dispatch or issue) stage 1012, a register read/memory read stage 1010, an execute stage 1016, a write back/memory write stage 1018, an exception handling stage 1022, and a commit stage 1024. In one embodiment, the processing device 110 of FIG. 1 may include some or all of the functionality of the core 1090. The memory unit 1070 includes TPM firmware 1099 which may correspond to the TPM firmware 115 of FIG. 1.

FIG. 10B is a block diagram illustrating an in-order architecture core and a register renaming logic, out-of-order issue/execution logic that may be included in a processor according to at least one embodiment of the disclosure. In FIG. 10B, arrows denote a coupling between two or more units and the direction of the arrow indicates a direction of data flow between those units. FIG. 10B shows processor core 1090 including a front end unit 1030 coupled to an execution engine unit 1050, and both are coupled to a memory unit 1070.

The core 1090 may be a reduced instruction set computing (RISC) core, a complex instruction set computing (CISC) core, a very long instruction word (VLIW) core, or a hybrid or alternative core type. As yet another option, the core 1090 may be a special-purpose core, such as, for example, a network or communication core, compression engine, graphics core, or the like.

The front end unit 1030 includes a branch prediction unit 1032 coupled to an instruction cache unit 1034, which is coupled to an instruction translation lookaside buffer (TLB) 1036, which is coupled to an instruction fetch unit 1038, which is coupled to a decode unit 1040. The decode unit or decoder may decode instructions, and generate as an output one or more micro-operations, micro-code entry points, microinstructions, other instructions, or other control signals, which are decoded from, or which otherwise reflect, or are derived from, the original instructions. The decoder may be implemented using various different mechanisms. Examples of suitable mechanisms include, but are not limited to, look-up tables, hardware implementations, programmable logic arrays (PLAs), microcode read only memories (ROMs), etc. The instruction cache unit 1034 is further coupled to a level 2 (L2) cache unit 1076 in the memory unit 1070. The decode unit 1040 is coupled to a rename/allocator unit 1052 in the execution engine unit 1050.

The execution engine unit 1050 includes the rename/allocator unit 1052 coupled to a retirement unit 1054 and a set of one or more scheduler unit(s) 1056. The scheduler unit(s) 1056 represents any number of different schedulers, including reservations stations, central instruction window, etc. The scheduler unit(s) 1056 is coupled to the physical register file(s) unit(s) 1058. Each of the physical register file(s) units 1058 represents one or more physical register files, different ones of which store one or more different data types, such as scalar integer, scalar floating point, packed integer, packed floating point, vector integer, vector floating point, etc., status (e.g., an instruction pointer that is the address of the next instruction to be executed), etc. The physical register file(s) unit(s) 1058 is overlapped by the retirement unit 1054 to illustrate various ways in which register renaming and out-of-order execution may be implemented (e.g., using a reorder buffer(s) and a retirement register file(s), using a future file(s), a history buffer(s), and a retirement register file(s); using a register maps and a pool of registers; etc.). Generally, the architectural registers are visible from the outside of the processor or from a programmer's perspective. The registers are not limited to any known particular type of circuit. Various different types of registers are suitable as long as they are capable of storing and providing data as described herein. Examples of suitable registers include, but are not limited to, dedicated physical registers, dynamically allocated physical registers using register renaming, combinations of dedicated and dynamically allocated physical registers, etc. The retirement unit 1054 and the physical register file(s) unit(s) 1058 are coupled to the execution cluster(s) 1060. The execution cluster(s) 1060 includes a set of one or more execution units 162 and a set of one or more memory access units 1064. The execution units 1062 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 1056, physical register file(s) unit(s) 1058, and execution cluster(s) 1060 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 1064). It should also be understood that where separate pipelines are used, one or more of these pipelines may be out-of-order issue/execution and the rest in-order.

The set of memory access units 1064 is coupled to the memory unit 1070, which includes a data TLB unit 1072 coupled to a data cache unit 1074 coupled to a level 2 (L2) cache unit 1076. In one exemplary embodiment, the memory access units 1064 may include a load unit, a store address unit, and a store data unit, each of which is coupled to the data TLB unit 1072 in the memory unit 1070. The L2 cache unit 1076 is coupled to one or more other levels of cache and eventually to a main memory.

By way of example, the exemplary register renaming, out-of-order issue/execution core architecture may implement the pipeline 1000 as follows: 1) the instruction fetch 1038 performs the fetch and length decoding stages 1002 and 1004; 2) the decode unit 1040 performs the decode stage 1006; 3) the rename/allocator unit 1052 performs the allocation stage 1008 and renaming stage 1010; 4) the scheduler unit(s) 1056 performs the schedule stage 1012; 5) the physical register file(s) unit(s) 1058 and the memory unit 1070 perform the register read/memory read stage 1010; the execution cluster 1060 perform the execute stage 1016; 6) the memory unit 1070 and the physical register file(s) unit(s) 1058 perform the write back/memory write stage 1018; 7) various units may be involved in the exception handling stage 1022; and 8) the retirement unit 1054 and the physical register file(s) unit(s) 1058 perform the commit stage 1024.

The core 1090 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.).

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes a separate instruction and data cache units 1034/1074 and a shared L2 cache unit 1076, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

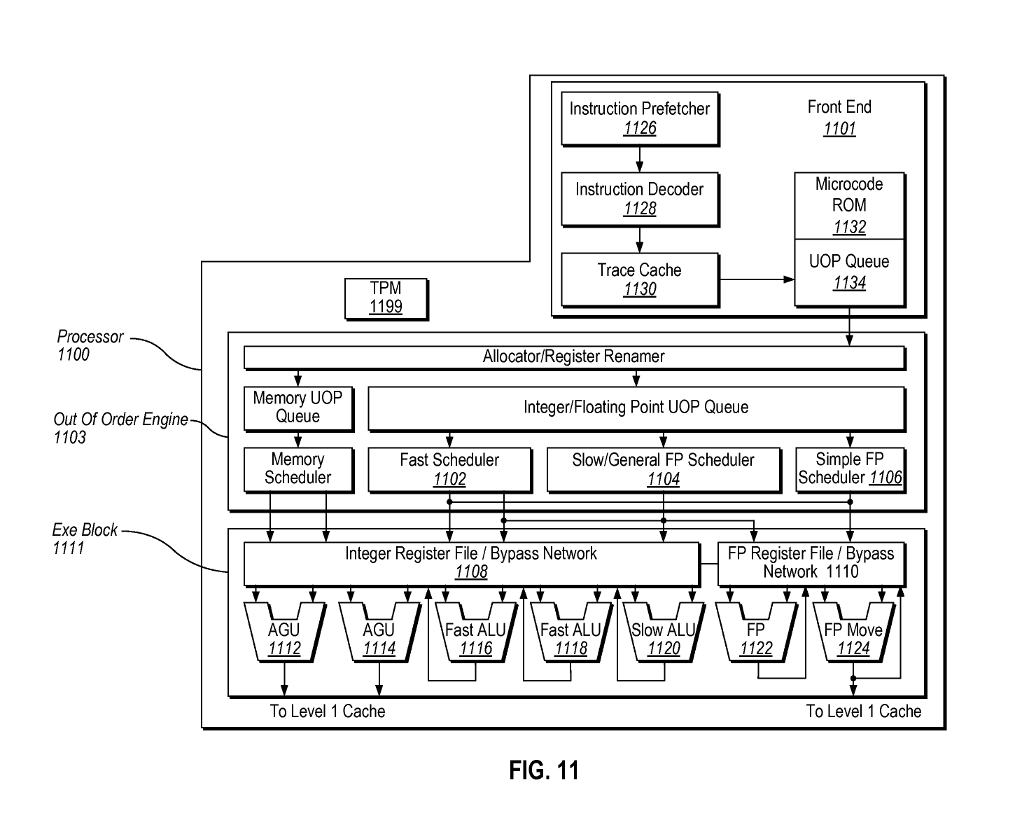

FIG. 11 is a block diagram of the micro-architecture for a processor 1100 that includes logic circuits to perform instructions in accordance with one embodiment of the present invention. In some embodiments, an instruction in accordance with one embodiment can be implemented to operate on data elements having sizes of byte, word, doubleword, quadword, etc., as well as datatypes, such as single and double precision integer and floating point datatypes. In one embodiment the in-order front end 1101 is the part of the processor 1100 that fetches instructions to be executed and prepares them to be used later in the processor pipeline. The front end 1101 may include several units. In one embodiment, the instruction prefetcher 1126 fetches instructions from memory and feeds them to an instruction decoder 1128 which in turn decodes or interprets them. For example, in one embodiment, the decoder decodes a received instruction into one or more operations called “micro-instructions” or “micro-operations” (also called micro op or uops) that the machine can execute. In other embodiments, the decoder parses the instruction into an opcode and corresponding data and control fields that are used by the micro-architecture to perform operations in accordance with one embodiment. In one embodiment, the trace cache 1130 takes decoded uops and assembles them into program ordered sequences or traces in the uop queue 1134 for execution. When the trace cache 1130 encounters a complex instruction, the microcode ROM 1132 provides the uops needed to complete the operation. In one embodiment, the processing device 110 of FIG. 1 may include some or all of the components and functionality of the processor 1100. The processor 1100 includes TPM firmware 1199 which may correspond to the TPM firmware 115 of FIG. 1.

Some instructions are converted into a single micro-op, whereas others need several micro-ops to complete the full operation. In one embodiment, if more than four micro-ops are needed to complete an instruction, the decoder 1128 accesses the microcode ROM 1132 to do the instruction. For one embodiment, an instruction can be decoded into a small number of micro ops for processing at the instruction decoder 1128. In another embodiment, an instruction can be stored within the microcode ROM 1132 should a number of micro-ops be needed to accomplish the operation. The trace cache 1130 refers to an entry point programmable logic array (PLA) to determine a correct micro-instruction pointer for reading the micro-code sequences to complete one or more instructions in accordance with one embodiment from the micro-code ROM 1132. After the microcode ROM 1132 finishes sequencing micro-ops for an instruction, the front end 1101 of the machine resumes fetching micro-ops from the trace cache 1130.

The out-of-order execution engine 1103 is where the instructions are prepared for execution. The out-of-order execution logic has a number of buffers to smooth out and re-order the flow of instructions to optimize performance as they go down the pipeline and get scheduled for execution. The allocator logic allocates the machine buffers and resources that each uop needs in order to execute. The register renaming logic renames logic registers onto entries in a register file. The allocator also allocates an entry for each uop in one of the two uop queues, one for memory operations and one for non-memory operations, in front of the instruction schedulers: memory scheduler, fast scheduler 1102, slow/general floating point scheduler 1104, and simple floating point scheduler 1106. The uop schedulers 1102, 1104, 1106, determine when a uop is ready to execute based on the readiness of their dependent input register operand sources and the availability of the execution resources the uops need to complete their operation. The fast scheduler 1102 of one embodiment can schedule on each half of the main clock cycle while the other schedulers can only schedule once per main processor clock cycle. The schedulers arbitrate for the dispatch ports to schedule uops for execution.

Register files 1108, 1110, sit between the schedulers 1102, 1104, 1106, and the execution units 1112, 1114, 1116, 1118, 1120, 1122, and 1124 in the execution block 1111. There is a separate register file 1108, 1110, for integer and floating point operations, respectively. Each register file 1108, 1110, of one embodiment also includes a bypass network that can bypass or forward just completed results that have not yet been written into the register file to new dependent uops. The integer register file 1108 and the floating point register file 1110 are also capable of communicating data with the other. For one embodiment, the integer register file 1108 is split into two separate register files, one register file for the low order 32 bits of data and a second register file for the high order 32 bits of data. The floating point register file 1110 of one embodiment has 128 bit wide entries because floating point instructions typically have operands from 64 to 128 bits in width.

The execution block 1111 contains the execution units 1112, 1114, 1116, 1118, 1120, 1122, 1124, where the instructions are actually executed. This section includes the register files 1108, 1110, that store the integer and floating point data operand values that the micro-instructions need to execute. The processor 1100 of one embodiment is comprised of a number of execution units: address generation unit (AGU) 1112, AGU 1114, fast ALU 1116, fast ALU 1118, slow ALU 1120, floating point ALU 1122, floating point move unit 1124. For one embodiment, the floating point execution blocks 1122, 1124, execute floating point, MMX, SIMD, and SSE, or other operations. The floating point ALU 1122 of one embodiment includes a 64 bit by 64 bit floating point divider to execute divide, square root, and remainder micro-ops. For embodiments of the present invention, instructions involving a floating point value may be handled with the floating point hardware. In one embodiment, the ALU operations go to the high-speed ALU execution units 1116, 1118. The fast ALUs 1116, 1118, of one embodiment can execute fast operations with an effective latency of half a clock cycle. For one embodiment, most complex integer operations go to the slow ALU 1120 as the slow ALU 1120 includes integer execution hardware for long latency type of operations, such as a multiplier, shifts, flag logic, and branch processing. Memory load/store operations are executed by the AGUs 1112, 1114. For one embodiment, the integer ALUs 1116, 1118, 1120, are described in the context of performing integer operations on 64 bit data operands. In alternative embodiments, the ALUs 1116, 1118, 1120, can be implemented to support a variety of data bits including 16, 32, 128, 256, etc. Similarly, the floating point units 1122, 1124, can be implemented to support a range of operands having bits of various widths. For one embodiment, the floating point units 1122, 1124, can operate on 128 bits wide packed data operands in conjunction with SIMD and multimedia instructions.

In one embodiment, the uops schedulers 1102, 1104, 1106, dispatch dependent operations before the parent load has finished executing. As uops are speculatively scheduled and executed in processor 1100, the processor 1100 also includes logic to handle memory misses. If a data load misses in the data cache, there can be dependent operations in flight in the pipeline that have left the scheduler with temporarily incorrect data. A replay mechanism tracks and re-executes instructions that use incorrect data. Only the dependent operations need to be replayed and the independent ones are allowed to complete. The schedulers and replay mechanism of one embodiment of a processor are also designed to catch instruction sequences for text string comparison operations.

The term “registers” may refer to the on-board processor storage locations that are used as part of instructions to identify operands. In other words, registers may be those that are usable from the outside of the processor (from a programmer's perspective). However, the registers of an embodiment should not be limited in meaning to a particular type of circuit. Rather, a register of an embodiment is capable of storing and providing data, and performing the functions described herein. The registers described herein can be implemented by circuitry within a processor using any number of different techniques, such as dedicated physical registers, dynamically allocated physical registers using register renaming, combinations of dedicated and dynamically allocated physical registers, etc. In one embodiment, integer registers store thirty-two bit integer data. A register file of one embodiment also contains eight multimedia SIMD registers for packed data. For the discussions below, the registers are understood to be data registers designed to hold packed data, such as 64 bits wide MMX™ registers (also referred to as ‘mm’ registers in some instances) in microprocessors enabled with MMX technology from Intel Corporation of Santa Clara, Calif. These MMX registers, available in both integer and floating point forms, can operate with packed data elements that accompany SIMD and SSE instructions. Similarly, 128 bits wide XMM registers relating to SSE2, SSE3, SSE4, or beyond (referred to generically as “SSEx”) technology can also be used to hold such packed data operands. In one embodiment, in storing packed data and integer data, the registers do not need to differentiate between the two data types. In one embodiment, integer and floating point are either contained in the same register file or different register files. Furthermore, in one embodiment, floating point and integer data may be stored in different registers or the same registers.

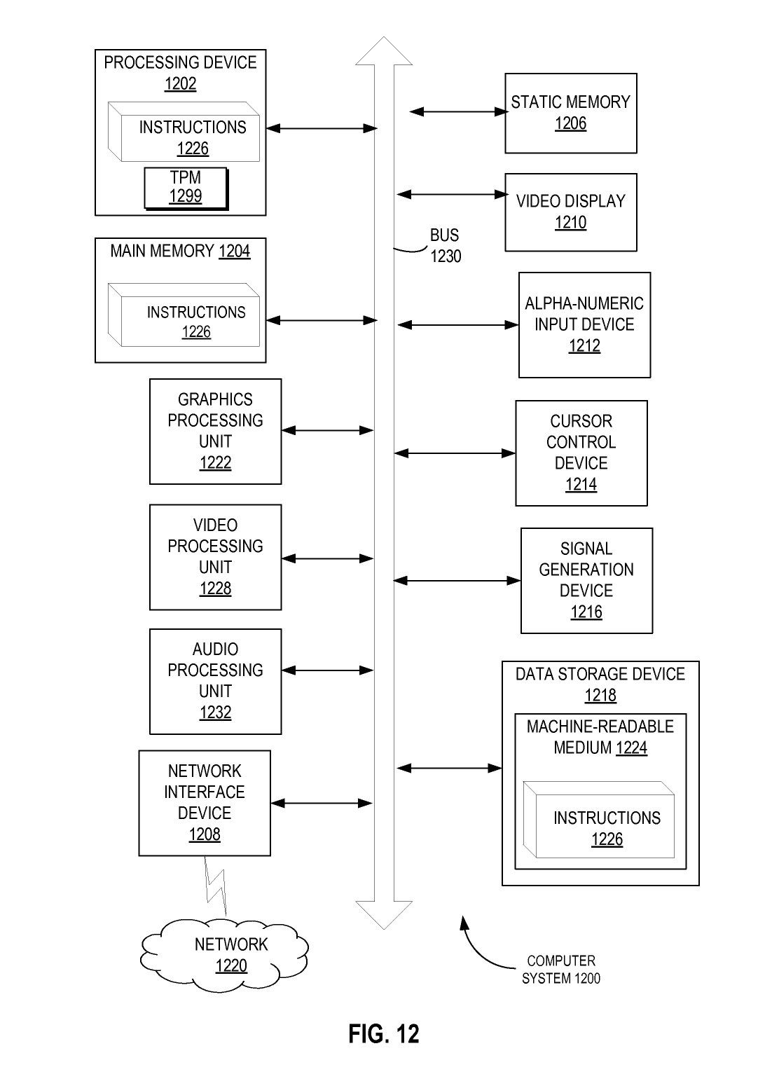

FIG. 12 illustrates a diagrammatic representation of a machine in the example form of a computer system 1200 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client device in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a smartphone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1200 includes a processing device 1202, a main memory 1204 (e.g., read-only memory (ROM), flash memory, dynamic random access memory (DRAM) (such as synchronous DRAM (SDRAM) or DRAM (RDRAM), etc.), a static memory 1206 (e.g., flash memory, static random access memory (SRAM), etc.), and a data storage device 1218, which communicate with each other via a bus 1230.

Processing device 1202 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 1202 may also be one or more special-purpose processing devices such as an application specific integrated circuit (ASIC), a field programmable gate array (FPGA), a digital signal processor (DSP), network processor, or the like. In one embodiment, processing device 1202 may include one or processing cores. The processing device 1202 is configured to execute the instructions 1226 of a system management mode module for performing the operations discussed herein. In one embodiment, the processing device 1202 may correspond to the processing device 110 of FIG. 1. The processing device 1020 includes TPM firmware 1299 which may correspond to the TPM firmware 115 of FIG. 1.

The computer system 1200 may further include a network interface device 1208 communicably coupled to a network 1220. The computer system 1200 also may include a video display unit 1210 (e.g., a liquid crystal display (LCD) or a cathode ray tube (CRT)), an alphanumeric input device 1212 (e.g., a keyboard), a cursor control device 1214 (e.g., a mouse), a signal generation device 1216 (e.g., a speaker), or other peripheral devices. Furthermore, computer system 1200 may include a graphics processing unit 1222, a video processing unit 1228, and an audio processing unit 1232. In another embodiment, the computer system 1200 may include a chipset (not illustrated), which refers to a group of integrated circuits, or chips, that are designed to work with the processing device 1202 and controls communications between the processing device 1202 and external devices. For example, the chipset may be a set of chips on a motherboard that links the processing device 1202 to very high-speed devices, such as main memory 1204 and graphic controllers, as well as linking the processing device 1202 to lower-speed peripheral buses of peripherals, such as USB, PCI or ISA buses.

The data storage device 1218 may include a computer-readable storage medium 1224 on which is stored instructions 1226 embodying any one or more of the methodologies of functions described herein. The instructions 1226 may also reside, completely or at least partially, within the main memory 1204 and/or within the processing device 1202 during execution thereof by the computer system 1200; the main memory 1204 and the processing device 1202 also constituting computer-readable storage media.

The computer-readable storage medium 1224 may also be used to store instructions 1226 utilizing logic and/or a software library containing methods that call the above applications. While the computer-readable storage medium 1224 is shown in an example embodiment to be a single medium, the term “computer-readable storage medium” or “computer-readable medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instruction for execution by the machine and that cause the machine to perform any one or more of the methodologies of the present embodiments. The term “computer-readable storage medium” shall accordingly be taken to include, but not be limited to, solid-state memories, and optical and magnetic media.

In the above description, numerous details are set forth. It will be apparent, however, to one of ordinary skill in the art having the benefit of this disclosure, that embodiments may be practiced without these specific details. In some instances, well-known structures and devices are shown in block diagram form, rather than in detail, in order to avoid obscuring the description.

Although the embodiments may be herein described with reference to specific integrated circuits, such as in computing platforms or microprocessors, other embodiments are applicable to other types of integrated circuits and logic devices. Similar techniques and teachings of embodiments described herein may be applied to other types of circuits or semiconductor devices. For example, the disclosed embodiments are not limited to desktop computer systems or Ultrabooks™ and may be also used in other devices, such as handheld devices, tablets, other thin notebooks, systems on a chip (SOC) devices, and embedded applications. Some examples of handheld devices include cellular phones, Internet protocol devices, smartphones, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below.

Although the embodiments are herein described with reference to a processor or processing device, other embodiments are applicable to other types of integrated circuits and logic devices. Similar techniques and teachings of embodiments of the present invention can be applied to other types of circuits or semiconductor devices that can benefit from higher pipeline throughput and improved performance. The teachings of embodiments of the present invention are applicable to any processor or machine that performs data manipulations. However, the present invention is not limited to processors or machines that perform 512 bit, 256 bit, 128 bit, 64 bit, 32 bit, and/or 16 bit data operations and can be applied to any processor and machine in which manipulation or management of data is performed. In addition, the following description provides examples, and the accompanying drawings show various examples for the purposes of illustration. However, these examples should not be construed in a limiting sense as they are merely intended to provide examples of embodiments of the present invention rather than to provide an exhaustive list of all possible implementations of embodiments of the present invention.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. The blocks described herein can be hardware, software, firmware, or a combination thereof.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “detecting,” “initiating,” “determining,” “continuing,” “halting,” “receiving,” “recording,” or the like, refer to the actions and processes of a computing system, or similar electronic computing device, that manipulates and transforms data represented as physical (e.g., electronic) quantities within the computing system's registers and memories into other data similarly represented as physical quantities within the computing system memories or registers or other such information storage, transmission or display devices.

The words “example” or “exemplary” are used herein to mean serving as an example, instance or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Also, the terms “first,” “second,” “third,” “fourth,” etc. as used herein are meant as labels to distinguish among different elements and may not necessarily have an ordinal meaning according to their numerical designation.

Embodiments descried herein may also relate to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer-readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory, or any type of media suitable for storing electronic instructions. The term “computer-readable storage medium” should be taken to include a single medium or multiple media (e.g., a centralized or distributed database and/or associated caches and servers) that store the one or more sets of instructions. The term “computer-readable medium” shall also be taken to include any medium that is capable of storing, encoding or carrying a set of instructions for execution by the machine and that causes the machine to perform any one or more of the methodologies of the present embodiments. The term “computer-readable storage medium” shall accordingly be taken to include, but not be limited to, solid-state memories, optical media, magnetic media, any medium that is capable of storing a set of instructions for execution by the machine and that causes the machine to perform any one or more of the methodologies of the present embodiments.

The algorithms and displays presented herein are not inherently related to any particular computer or other apparatus. Various general-purpose systems may be used with programs in accordance with the teachings herein, or it may prove convenient to construct a more specialized apparatus to perform the operations. The required structure for a variety of these systems will appear from the description below. In addition, the present embodiments are not described with reference to any particular programming language. It will be appreciated that a variety of programming languages may be used to implement the teachings of the embodiments as described herein.

The following examples pertain to further embodiments.

Example 1 is a method of booting a processing device, wherein the method comprises initiating a boot-up process on the processing device, entering a system management mode of the processing device, executing, in the system management mode, trusted platform module firmware to cryptographically sign data generated during the boot-up process, and transmitting the cryptographically signed data to a remote server.

Example 2 may optionally extend the subject matter of example 1. In example 2, initiating the boot-up process is performed in response to receiving power at the processing device.

Example 3 may optionally extend the subject matter of examples 1 or 2. In example 3, the trusted platform module firmware cryptographically signs the data using a key derived from a set of one-time programmable fuses of the processing device.

Example 4 may optionally extend the subject matter of example 3. In example 4, the key is derived from the set of one-time programmable fuses using read-only memory code of the processing device.

Example 5 may optionally extend the subject matter of any of examples 1-4. In example 5, the method further comprises write protecting, in the system management mode, a recovery image for the processing device.

Example 6 may optionally extend the subject matter of any of examples 1-5. In example 6, the method further comprises loading, in the system management mode, one or more opcodes into a memory controller.

Example 7 may optionally extend the subject matter of example 6. In example 7, the memory controller comprises opcode filtering hardware that prevents the memory controller from issuing the one or more opcodes to a memory.

Example 8 is a device comprising a serial peripheral interface (SPI) flash memory storing a recovery image and trusted platform module firmware to perform one or more cryptographic functions and a processing device coupled to the SPI flash memory. The processing device comprises an SPI controller to transmit data to and receive data from the memory, the SPI controller comprising an opcode filter that prevents the SPI controller from issuing a subset of opcodes to the SPI flash memory and a processing module to execute the processing device in a system management mode. The processing module is further to, in the system management mode, execute the trusted platform module firmware and write protect the recovery image.

Example 9 may optionally extend the subject matter of example 8. In example 9, the processing module is further to, in the system management mode, load the subset of opcodes from a descriptor in the SPI flash memory into the SPI controller and write protect the descriptor.

Example 10 may optionally extend the subject matter of example 8 or 9. In example 10, the one or more cryptographic functions comprises calling a replay protected monotonic counter stored on the SPI flash memory.

Example 11 may optionally extend the subject matter of any of examples 8-10. In example 11, the device further comprises a set of one-time programmable fuses to store a device identifier of the processing device, wherein the one or more cryptographic functions comprises transmitting a SPI Flash key based on the device identifier to the SPI flash memory.

Example 12 may optionally extend the subject matter of any of examples 8-11. In example 12, the SPI flash memory stores a descriptor specifying an address range of the recovery image and the processing module is further to, in the system management mode, write protect the descriptor.

Example 13 may optionally extend the subject matter of any of examples 8-12. In example 13, the SPI flash memory stores a primary image that is modifiable by the processing module and write protected against modification by an operating system or other software executed by the processing device.

Example 14 may optionally extend the subject matter of any of examples 8-13. In example 14, the device further comprises a sensing element to generate sensor data to be received by the processing device.

Example 15 may optionally extend the subject matter of example 14. In example 15, the sensing element comprises an environmental sensor.

Example 16 is a package comprising a processing device comprising a processing module to execute in a system management mode and further comprising a non-volatile memory storing cryptographic firmware to execute one or more cryptographic functions in the system management mode.

Example 17 may optionally extend the subject matter of example 16. In example 17, the processing module is to execute the cryptographic firmware during a boot-up of the processing device to cryptographically sign data generated during the boot-up.

Example 18 may optionally extend the subject matter of example 17. In example 18, the package further comprises a network interface to transmit the cryptographically signed data to a remote server.

Example 19 may optionally extend the subject matter of any of examples 16-18. In example 19, the package further comprises a set of one-time programmable fuses to store a device identifier of the processing device and read-only-memory code to generate one or more cryptographic keys based on the device identifier, wherein the cryptographic firmware is to execute one or more cryptographic functions in the system management mode using at least one of the cryptographic keys.

Example 20 may optionally extend the subject matter of any of examples 16-19. In example 20, the processing device further comprises a non-volatile memory controller to interface with the non-volatile memory, the non-volatile memory controller comprising opcode filtering hardware that prevents the non-volatile memory controller from issuing a subset of opcodes to the non-volatile memory.

Example 21 is an apparatus comprising means for initiating a boot-up process on the processing device, means for entering a system management mode of the processing device, means for executing, in the system management mode, trusted platform module firmware to cryptographically sign data generated during the boot-up process, and means for transmitting the cryptographically signed data to a remote server.

Example 22 may optionally extend the subject matter of example 21. In example 22, the means for initiating the boot-up process comprises means for initiating the boot-up process in response to receiving power at the processing device.

Example 23 may optionally extend the subject matter of examples 21 or 22. In example 23, the trusted platform module firmware cryptographically signs the data using a key derived from a set of one-time programmable fuses of the processing device.

Example 24 may optionally extend the subject matter of example 23. In example 24, the key is derived from the set of one-time programmable fuses using read-only memory code of the processing device.

Example 25 may optionally extend the subject matter of any of examples 21-24. In example 25, the apparatus further comprises means for write protecting, in the system management mode, a recovery image for the processing device.

Example 26 may optionally extend the subject matter of any of examples 21-25. In example 26, the apparatus further comprises means for loading, in the system management mode, one or more opcodes into a memory controller.

Example 27 may optionally extend the subject matter of example 26. In example 27, the memory controller comprises opcode filtering hardware that prevents the memory controller from issuing the one or more opcodes to a memory.

Example 28 is at least one machine readable medium comprising a plurality of instructions that, in response to be executed on a computing device, cause the computing device to carry out a method according to any of examples 1-7.

Example 29 is an apparatus comprising means for performing any of claims 1-7.

The above description sets forth numerous specific details such as examples of specific systems, components, methods and so forth, in order to provide a good understanding of several embodiments. It will be apparent to one skilled in the art, however, that at least some embodiments may be practiced without these specific details. In other instances, well-known components or methods are not described in detail or are presented in simple block diagram format in order to avoid unnecessarily obscuring the present embodiments. Thus, the specific details set forth above are merely exemplary. Particular implementations may vary from these exemplary details and still be contemplated to be within the scope of the present embodiments.

It is to be understood that the above description is intended to be illustrative and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A method of booting a processing device, the method comprising:
initiating a boot-up process on the processing device;
entering a system management mode of the processing device;
executing, in the system management mode, trusted platform module firmware to cryptographically sign data generated during the boot-up process; and
transmitting the cryptographically signed data to a remote server.

2. The method of claim 1, wherein initiating the boot-up process is performed in response to receiving power at the processing device.

3. The method of claim 1, wherein the trusted platform module firmware cryptographically signs the data using a key derived from a set of one-time programmable fuses of the processing device.

4. The method of claim 3, wherein the key is derived from the set of one-time programmable fuses using read-only memory code of the processing device.

5. The method of claim 1, further comprising write protecting, in the system management mode, a recovery image for the processing device.

6. The method of claim 1, further comprising loading, in the system management mode, one or more opcodes into a memory controller.

7. The method of claim 6, wherein the memory controller comprises opcode filtering hardware that prevents the memory controller from issuing the one or more opcodes to a memory.

8. A device comprising:
a serial peripheral interface (SPI) flash memory storing a recovery image and trusted platform module firmware to perform one or more cryptographic functions; and
a processing device coupled to the SPI flash memory, the processing device comprising:
an SPI controller to transmit data to and receive data from the memory, the SPI controller comprising an opcode filter that prevents the SPI controller from issuing a subset of opcodes to the SPI flash memory; and
a processing module to execute the processing device in a system management mode,
wherein the processing module is further to, in the system management mode, execute the trusted platform module firmware and write protect the recovery image.

9. The device of claim 8, wherein the processing module is further to, in the system management mode, load the subset of opcodes from a descriptor in the SPI flash memory into the SPI controller and write protect the descriptor.

10. The device of claim 8, wherein the one or more cryptographic functions comprises calling a replay protected monotonic counter stored on the SPI flash memory.

11. The device of claim 8, further comprising a set of one-time programmable fuses to store a device identifier of the processing device, wherein the one or more cryptographic functions comprises transmitting a SPI Flash key based on the device identifier to the SPI flash memory.

12. The device of claim 8, wherein the SPI flash memory stores a descriptor specifying an address range of the recovery image and the processing module is further to, in the system management mode, write protect the descriptor.

13. The device of claim 8, wherein the SPI flash memory stores a primary image that is modifiable by the processing module and write protected against modification by an operating system or other software executed by the processing device.

14. The device of claim 8, further comprising a sensing element to generate sensor data to be received by the processing device.

15. The device of claim 14, wherein the sensing element comprises an environmental sensor.

16. A package comprising:
a processing device comprising a processing module to execute in a system management mode; and
a non-volatile memory storing cryptographic firmware to execute one or more cryptographic functions in the system management mode.

17. The package of claim 16, wherein the processing module is to execute the cryptographic firmware during a boot-up of the processing device to cryptographically sign data generated during the boot-up.

18. The package of claim 17, further comprising a network interface to transmit the cryptographically signed data to a remote server.

19. The package of claim 16, further comprising a set of one-time programmable fuses to store a device identifier of the processing device and read-only-memory code to generate one or more cryptographic keys based on the device identifier, wherein the cryptographic firmware is to execute one or more cryptographic functions in the system management mode using at least one of the cryptographic keys.

20. The package of claim 16, wherein the processing device further comprises a non-volatile memory controller to interface with the non-volatile memory, the non-volatile memory controller comprising opcode filtering hardware that prevents the non-volatile memory controller from issuing a subset of opcodes to the non-volatile memory.
